(19) United States
(12) Patent Application Publication
(10) Pub. No.: US 2008/0183679 A1
(43) Pub. Date: Jul. 31, 2008

(54) APPARATUS AND METHOD FOR GENERATING LEGAL DESCRIPTIONS

(75) Inventors: David H. Blackman, Moreno Valley, CA (US); Kurt M. Kluth, San Clemente, CA (US)

Correspondence Address: SNELL & WILMER LLP (OC), 600 ANTON BOULEVARD, SUITE 1400, COSTA MESA, CA, 92626, US

(73) Assignee: First American Title Insurance Company, Irvine, CA (US)

(21) Appl. No.: 12/018,091

(22) Filed: Jan. 22, 2008

Related U.S. Application Data
(60) Provisional application No. 60/886,638, filed on Jan. 25, 2007.

(51) Int. Cl. G06F 17/30; G06F 7/10

(52) U.S. Cl. 707/3; 707/102; 707/E17.014

(57) ABSTRACT

The invention provides an apparatus and method for generating legal descriptions in an electronic database. Database records of land interests are grouped in logical groups. Records in the grouping having legal descriptions are used to create a legal description template for the records in the group. The legal description template is applied to selected records in the group creating legal descriptions for the selected records. The legal descriptions are stored in the database with the created legal descriptions providing auto generated legal description for subsequent searches.

### CLAIM OF PRIORITY UNDER 35 U.S.C. §119

The present application for patent claims priority to U.S. Provisional Patent Application No. 60/886,638 filed on Jan. 25, 2007, entitled “APPARATUS AND METHOD FOR GENERATING LEGAL DESCRIPTIONS,” and assigned to the assignee hereof and hereby expressly incorporated by reference herein.

### BACKGROUND

1. Field

The present invention relates to land interest databases. More particularly, the present invention relates to an apparatus and method for generating legal descriptions for land interests stored in a land interest database.

2. Related Art

The title insurance underwriting process has traditionally been a labor intensive process. Title insurance underwriting is performed by large financial institutions that employ large numbers of employees such as title examiners, abstractors and searchers. These employees research title histories to evaluate the probability of a defect in title to a land interest. The research requires the searching of databases for title history evidence. Business rules are applied to the title history evidence to determine underwriting risk. Title insurance products are subsequently created for customers.

Title insurance protects a land purchaser and loan institutions from defects in title. A land purchaser may purchase title insurance to protect from an unknown claim of title. A home purchaser may be required to obtain title insurance prior to obtaining a mortgage on a property. Mortgagees and note purchasers may purchase title insurance to protect their collateral interest in a mortgage. Lien holders may also purchase title insurance to protect their collateral interest in the landowner's debt.

As part of the underwriting process, title searchers retrieve information related to land interests from one or more databases. The land interests may be indexed, queried or sorted by a tax identification number, an address, a short legal description or any other indicia of the land interest. As part of the search and title product creation process, a complete legal description of the land interest is needed. If a complete legal description is not available in the correct electronic format, an employee may need to key in a precise legal description.

Keying in the legal description of a land interest is time consuming and error prone. Formats for legal descriptions vary from county to county and from land tract to land tract. Legal descriptions are often long with references to other land parcels, easements, land and mineral rights as well as page numbers and map descriptions in the county's records. Two exemplary legal descriptions for land interests in two Los Angeles County condominiums are reproduced below.

1. A CONDOMINIUM COMPRISED OF: THAT PORTION OF LOT 1, TRACT NO. 51568, IN THE CITY OF LOS ANGELES, COUNTY OF LOS ANGELES, STATE OF CALIFORNIA, AS PER MAP RECORDED IN BOOK 1208, PAGE(S) 77 AND 78, OF MAPS, RECORDS OF SAID COUNTY, SHOWN AND DEFINED AS UNIT NO. 129 ON THE CONDOMINIUM PLAN RECORDED NOV. 10, 1994 AS INSTRUMENT NO. 94-2038654 OF OFFICIAL RECORDS OF SAID COUNTY. PARCEL 2: AN UNDIVIDED 1/187TH INTEREST IN AND TO LOT 1 OF SAID TRACT NO. 51568, IN THE CITY OF LOS ANGELES, COUNTY OF LOS ANGELES, STATE OF CALIFORNIA. EXCEPT THEREFROM THOSE PORTIONS SHOWN AND DEFINED AS UNITS 1 THROUGH 187 INCLUSIVE ON SAID CONDOMINIUM PLAN.

2. PARCEL 1: AN UNDIVIDED ONE/SIXTY-SIXTH ( 1/66TH) INTEREST IN AND TO LOT 1 OF TRACT 51069, AS PER MAP RECORDED IN BOOK 1201, PAGES 17 AND 18, INCLUSIVE OF MAPS, IN THE OFFICE OF THE COUNTY RECORDER OF SAID COUNTY. EXCEPT THEREFROM UNITS 120-138, 226-250 AND 320-341 AS SHOWN ON THE CONDOMINIUM PLAN REFERRED TO IN PARCEL 2. ALSO EXCEPT OIL, GAS AND OTHER HYDROCARBON SUBSTANCES AND MINERALS LYING BENEATH A VERTICAL DEPTH OF 500 FEET OF THE EXISTING SURFACE AND THE RIGHT TO PRODUCE THEREFROM. BUT WITHOUT THE RIGHT OF SURFACE ENTRY THEREON, AS RESERVED BY CLARA LUGO QUIROZ, VICENTE LUGO, LAURITA LUGO AND ANDRES G. LUGO, IN DEED RECORDED SEP. 27, 1968 AS INSTRUMENT NO. 979. ALSO EXCEPT THEREFROM TO GRANTOR ALL OIL AND GAS, HYDROCARBON AND OTHER MINERAL RIGHTS BELOW 500 FEET BENEATH THE SURFACE OF SAID LAND, WITHOUT THE RIGHT OF SURFACE ENTRY ALSO EXCEPTING AND RESERVING THEREFROM, EXCLUSIVE EASEMENTS FOR PARKING PURPOSES DESIGNATED AS DEPICTED ON THE CONDOMINIUM PLAN TOGETHER WITH THE RIGHT TO ASSIGN PARTICULAR PARKING SPACES. PARKING SPACES ARE SHOWN AS XT129 THRU XT141, T142, T143, XT144 THRU XT154, T155, T156, T157, XT158 THRU XT163, T164 THRU T167, XT176, T177, T178, XT179 THRU XT194, T195, T196, T197, XT198 THRU XT204, T205 THRU T209, XT218, T219, T220, XT221 THRU XT240, T241, T242, T243 AND XT244 THRU XT252 AND P123 AND P126 ON THE CONDOMINIUM PLAN RECORDED OCT. 20, 1994 AS INSTRUMENT NO. 94-1903423. PARCEL 2: UNIT 322 AS SHOWN ON THE CONDOMINIUM PLAN FOR LOT 1 OF TRACT 51069, RECORDED ON OCT. 20, 1994 AS INSTRUMENT NO. 94-1903423. PARCEL 3: AN EXCLUSIVE EASEMENT FOR PARKING PURPOSES APPURTENANT TO PARCELS ONE AND TWO TO USE THE FOLLOWING PARKING SPACES “XT137 AND T155”, AS DEPICTED ON THE CONDOMINIUM PLAN REFERRED TO IN PARCEL 2.

It should be apparent that keying in either of these legal descriptions accurately may take an employee five minutes or more. Moreover, the complexity of the legal description with a variety of numbers and unusual punctuation marks provides a substantive probability that the legal description will be entered with one or more typographical errors. This complexity is especially problematic at large title companies that may service over a million title customers a year. The time consuming keying process translates into many man years of labor and a significant production cost.

Those skilled in the art will recognize that there is a need for an apparatus and method for generating legal descriptions for land interests. The present invention addresses this need as well as others.

### SUMMARY

A title resource database stores title information for abstractors, examiners or searchers. The database may store numerous records having a complete legal description. The database may also store numerous records that do not have a complete legal description but have other indicia of the land interest such as a tax identification number, a street address, or a short legal description. Land interest records in the database may be sorted and grouped by the tract of land the land interest lies on. The land interest records may also be grouped by any other logical grouping where land interests are likely to have similar legal descriptions.

Records from one of the groups may be retrieved. One or more of the retrieved records may have a complete legal description. The legal descriptions from these records may be used to create a legal description template for land interest records in the group. The template may be applied to the land interest records in the group that do not have a legal description. Application of the template enables creation of a legal description for these records.

In one embodiment, the apparatus for generating a legal description includes a database having one or more groups of land interest records, and a computing device in communication with the database configured to display a group from the one or more groups of land interest records, display a legal description of at least one land interest record in the group, generate a list of each of the land interest records in the group that do not have a legal description, create a legal description template using the legal description of the at least one land interest record in the group, and apply the legal description template to each of the land interest records in the group that do not have a legal description.

### BRIEF DESCRIPTION OF THE DRAWINGS

The features, objects, and advantages of the present invention will become more apparent from the detailed description set forth below when taken in conjunction with the drawings, wherein:

FIG. 1 is a block diagram of an apparatus for generating legal descriptions according to an embodiment of the present invention.

FIG. 2 is a block diagram showing the process of creating legal descriptions by the TRD shown in FIG. 1 according to an embodiment of the present invention.

FIG. 3 shows an exemplary graphical user interface (GUI) for searching, retrieving and displaying groups of records (e.g., tract or book listings) of land interests according to an embodiment of the present invention.

FIG. 4 is an exemplary graphical user interface for generating and applying a land interest template to database records according to an embodiment of the present invention.

FIG. 5 is an exemplary graphical user interface showing search results and the type of legal description available in the database according to an embodiment of the present invention.

FIG. 6 is a flow diagram of a method for generating a legal description according to an embodiment of the present invention.

### DETAILED DESCRIPTION

Methods and apparatus that implement the embodiments of the various features of the disclosure will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

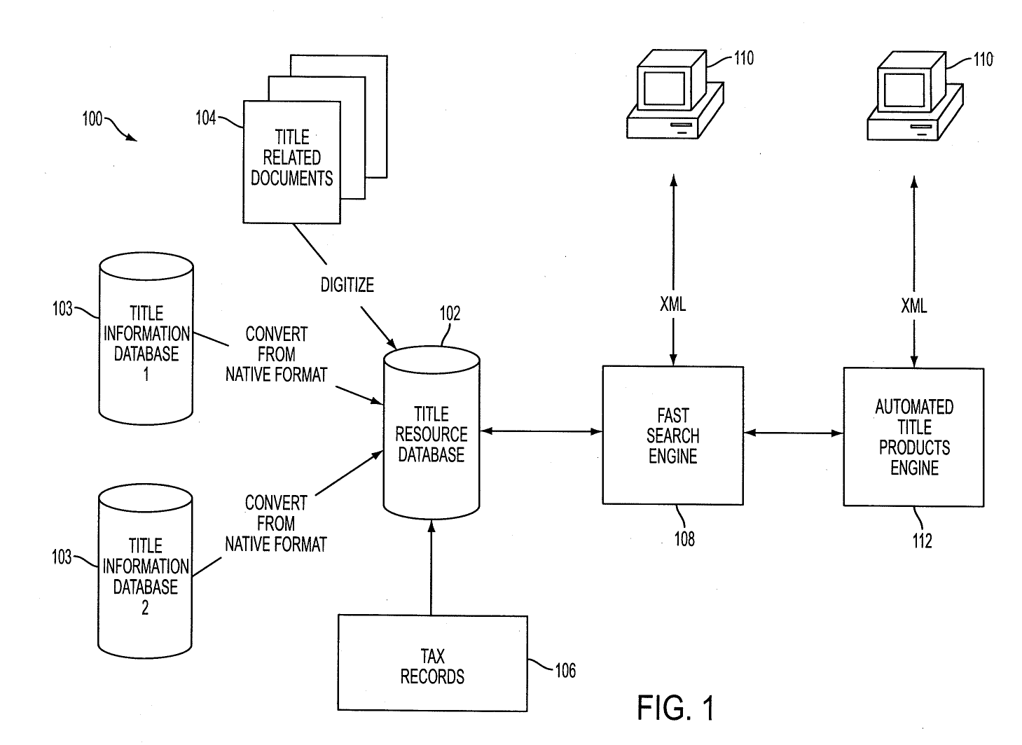

FIG. 1 shows a block diagram of an apparatus 100 for generating legal descriptions according to an embodiment of the invention. A title resource database (TRD) 102 has records that contain information about land interests. The records in the TRD 102 may be populated with title information retrieved and converted from native format from a plurality of electronic databases 103 (e.g., title information databases). The records may be populated with title information retrieved from paper title documents or records 104 that have been digitized by scanning or other means. The title information may include references to subdivision maps, recording details of documents, lot number(s), and other title related information. The records may also be populated with tax information from tax records 106. The tax information may include short legal descriptions, subdivision details, and other related details.

The TRD 102 serves as a single title resource database for warehousing title and tax information obtained from a variety of sources. The TRD 102 may warehouse any information related to a land or property interest. The TRD 102 may also contain records that are title research starters. That is, a record that the chain of title or title interest has been previously researched and vetted. Starters frequently serve as a starting point for title evidence searches.

A fast search engine 108 or other search engine may query the TRD 102 to retrieve title and tax information stored in the TRD 102. The search engine 108 may be networked with one or more personal computers 110. The use of extended markup language (XML) or other suitable networking protocol language may be used to provide remote access to the search engine functions.

An automated title products engine 112 may also be connected with the fast search engine 108. The automated title products engine 112 may also be networked using XML or other suitable network protocol language to provide one or more personal computers 110 remote access to the automated title products engine 112. The automated title products engine 112 may interact with the fast search engine 108 to automate the title search and title products generation process.

It will be appreciate by those skilled in the art that multiple topographies of this embodiment of the present invention are realizable. Notably, the TRD 102 may be a single database located in a single location or may be a distributed database with land interest records distributed over numerous database platforms. The use of information sources other than electronic databases 103, title related documents 104 and tax records 106 for populating the TRD 102 is also contemplated.

In this embodiment, the TRD 102 may be queried by the fast search engine 108. In alternate embodiments, the TRD 102 may be queried directly by a user input device, a networked computing device or similar devices.

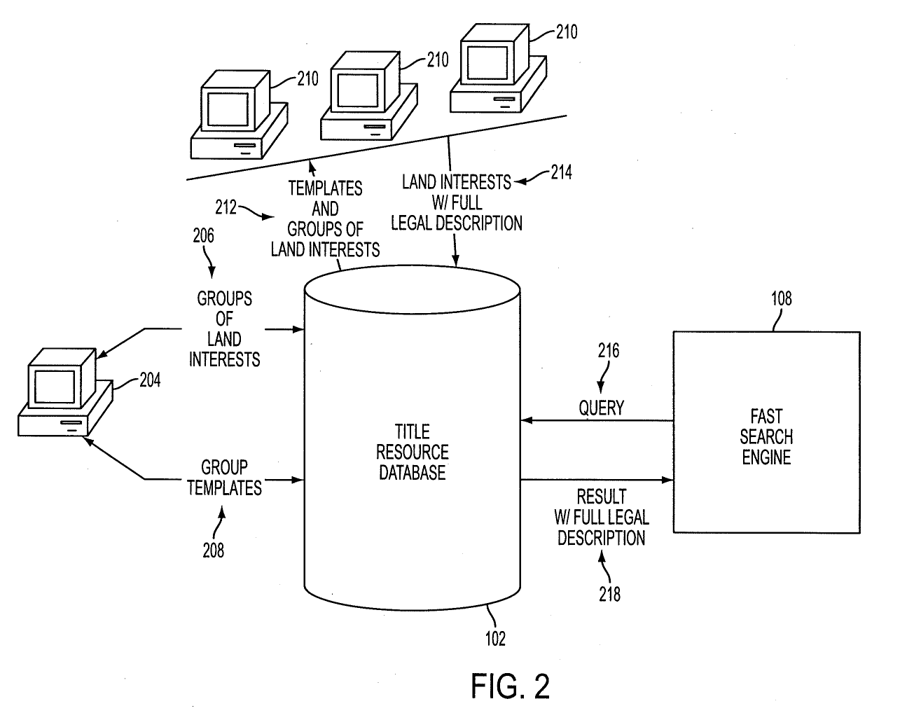

FIG. 2 is a block diagram showing the process of creating legal descriptions by the TRD 102 shown in FIG. 1 according to an embodiment of the present invention. The TRD 102 contains numerous land interest records having information derived from a variety of sources. The fast search engine 108 or a computing device 204 in communication with the TRD 102 may query the TRD 102 to identify and retrieve a group of land interests 206. The group of land interests 206 may be lots on a tract of land, condominium complexes in a unit, houses in a subdivision or any other logical group of land interests. The group may be a group of land interests having or likely to have similar legal descriptions. For example, the group of land interests may be similar because the lots are part of the same tract of land and therefore have similar legal descriptions.

The group of land interests 206 may be displayed or viewed on the computing device 204. In the group of land interests 206, there may be one or more records having a populated legal description field. The legal descriptions may be retrieved, viewed and edited to form a group template applicable to many, if not all, of the records in the group. The computing device 204 may be used to generate one or more group templates 208 associated with respective groups of land interests 206. The group templates 208 may be stored in the TRD 102.

Multiple remote data entry devices 210 may be in communication with the TRD 102. The data entry devices 210 may request a group template and groups of land interests 206. The operators of the data entry devices 210 may apply the group template to the group of records of land interests 206. The operators may cross check the created legal description for accuracy, correct any errors and save the new legal descriptions in the TRD 102. The multiple remote data entry devices 210 allow operators to easily populate the legal description field of the many records stored in the TRD 102. The land interest records with their newly created legal descriptions 214 may be stored in the TRD 102.

The fast search engine 108 or other search engine may query 216 the TRD 102. The TRD 102 may then return a query result with a full legal description 218. Having a full legal description associated with a land interest record may save considerable time for title searchers, abstractors and examiners, since they will not need to look up and/or manually key in a legal description. Moreover, if land interest records have a legal description, the title search process and the title product generation process may be more fully automated. This may result in a quicker and less costly underwriting process.

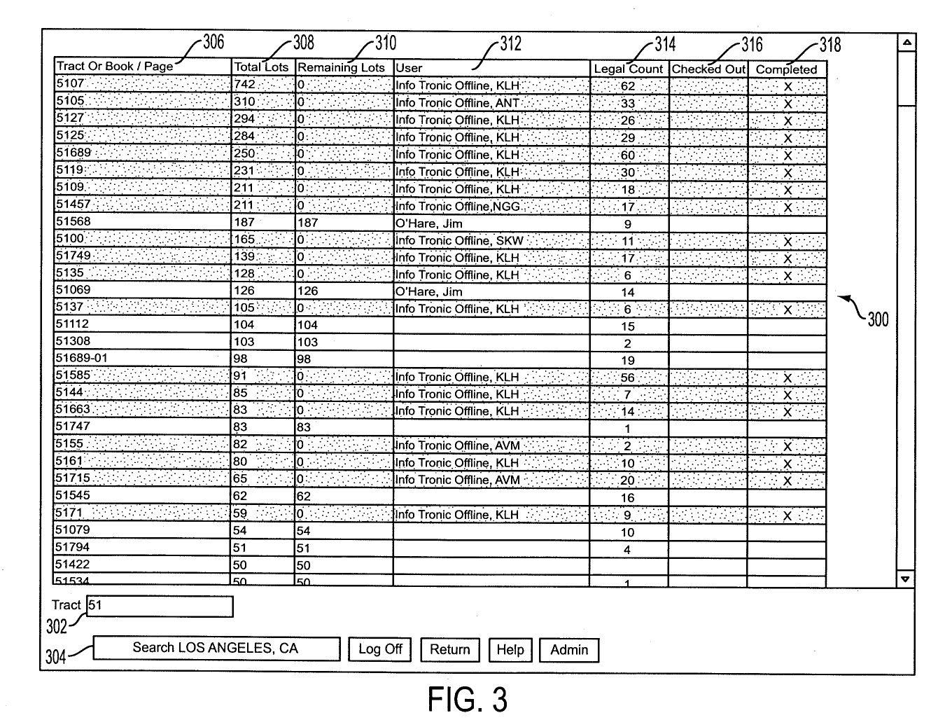

FIG. 3 shows an exemplary graphical user interface (GUI) 300 for searching, retrieving and displaying groups of records (e.g., tract or book listings) of land interests 306 according to an embodiment of the invention. The GUI 300 has a tract field 302 for entering a tract number or a portion of the tract number. In this case, the operator has entered 51 representing a portion of the tract number. The GUI 300 has a search button 304 that initiates a query of the TRD 102 for groups of records of land interests 306 having the value entered in the tract field 302. The TRD 102 searches its database for all records beginning with the tract number 51. The results of the query are displayed for an operator.

The first column shows the groups of records of land interests 306 that correspond to the entry in the tract field 302. The second column shows the total number of lots 308 for each group of records. The third column shows the remaining lots 310 that do not have a legal description for each group of records. That is, the lot records having a legal descriptions field that needs to be populated. The fourth column shows the user name of the individual or organization 312 currently working on populating the tract records. The fifth column shows the number of records 314 having legal descriptions. The sixth column indicates records that have been checked out 316. The seventh column shows the groups of land interests that have been completed 318.

The GUI 300 presented is exemplary and other GUI's may be used for searching groups of land interests. The groups may be organized by tracts or other logical groups. Alternate GUIs may have different fields for presenting other attributes of land groupings. They may also have different buttons or icons that execute searches, sort the land groups or launch other processes.

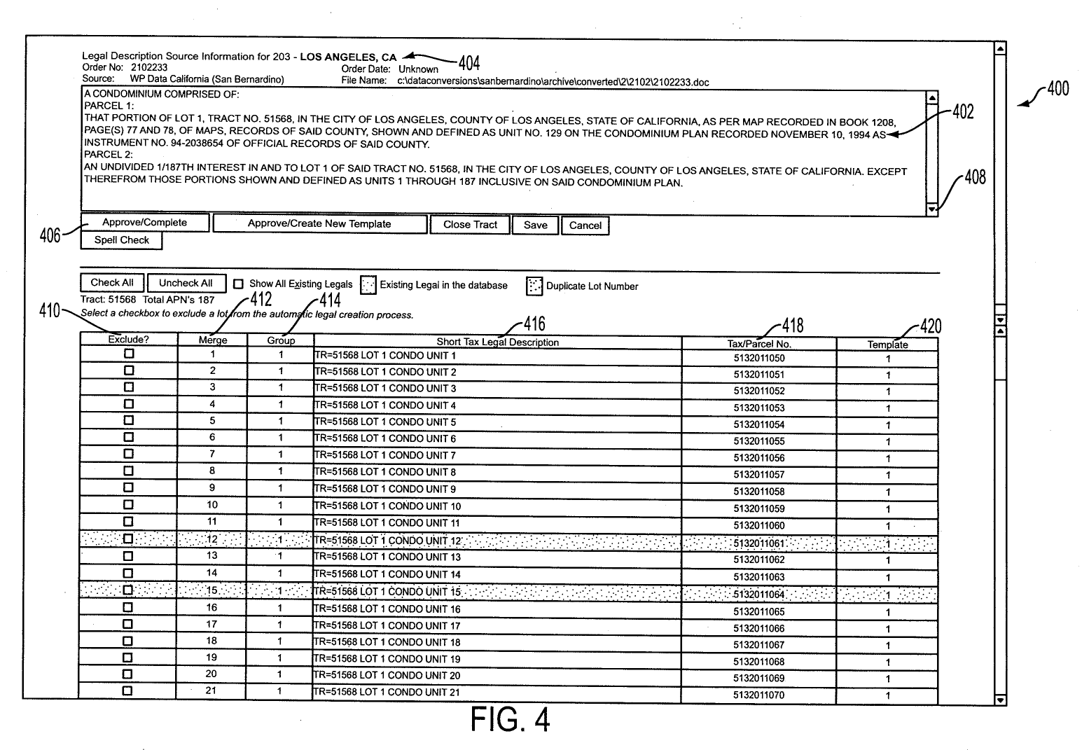

FIG. 4 shows an exemplary GUI 400 for generating and applying a legal description to one or more records. The GUI 400 has a legal description text box 402 for displaying and editing a legal description. The legal description text box 402 has a label 404 showing the source of the legal description information as well as other information for land interest records from where the legal description originated. The template is shown in the legal description text box 402.

A plurality of buttons or icons 406 allows an operator to approve the template, create a new template, close the tract, and save or cancel the template. The operator may also edit the template information displayed in the legal description text box 402. A scroll bar 408 allows an operator to scroll through the template.

The GUI 400 has a split screen with a listing of land interest records in the group of land interests presented in the lower half of the display. In this case, the land interests are condominiums units in a condominium complex. A first column allows an operator to select each of the land interests to exclude 410. A second column contains a numeric indicator 412 for the land interest in the group of land interests. A third column displays the group number indicator 414 for the group of land interests. A fourth column has a short tax legal description 416 for the land interest. A fifth column 418 has the tax parcel number for the land interest. A sixth column shows the template number 420 to be applied to the land interest.

The operator may view the legal description 402 for each of the land interests. The operator may select in the first column whether to exclude 410 a land interest from application of the template. This may be a reasonable choice for condominium units that have a legal description that may be very different from the template. For example, a penthouse or a common area may have a legal description far different than a standard condominium unit. The operator may prefer to manually enter a legal description for these legal description outliers.

It should be appreciated that the GUI 400 is exemplary. Alternate embodiments may be utilized for other GUI's 400 for applying a legal description template to a grouping of records. Automatic application of a template to a group of records is also provided as is auto-generation of a template through the use of a fuzzy logic algorithm or an expert system.

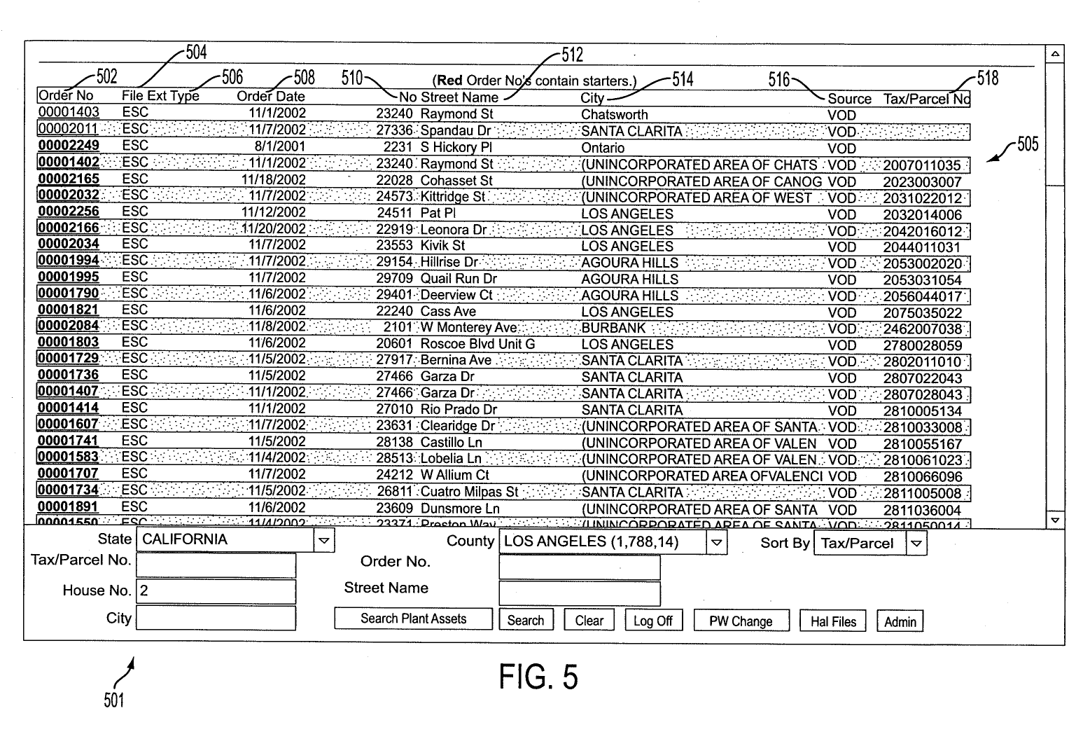

FIG. 5 shows an exemplary GUI 500 for displaying the results of a search according to an embodiment of the present invention. The GUI 500 has a plurality of search fields 501 that allow a title examiner, abstractor or searcher to enter search attributes. In this embodiment, the searcher may enter a state name, a tax or parcel number, a house number, a city, a county, an order number and/or a street name. Those skilled in the art will appreciate alternate embodiments may feature GUI's with different database search attributes. The search attributes may include any attribute of a land interest record stored in the TRD 102.

The GUI 500 has a split screen with the results of a search or query displayed in a scrollable window 505. A first column shows an order number 502 for a starter of the display land interest record. The starter, as explained above, is the land interest record for which a title search has previously been conducted. The starter may serve as a baseline for subsequent title searches. The second column shows a file extension 504 associated with the land interest record. The previous product type stored in the TRD 102 may have been converted from a native format where file extensions provide information or attributes of the land interest record. Records stored as Word or Word Perfect documents may have a file extension that provides information about the previous product. For example, the extension may indicate a policy, commitment or updated version.

The third column shows an origin (type) 506 of the legal description. Legal descriptions originating from the application of a template are labeled as “AutoGen”. Legal description manually entered through the fast search engine 108 may be labeled as “FASTPR”. A fourth column shows an order date 508 or date of creation of the legal description. A fifth column shows a street number 510 of the land interest. A sixth column shows a street name 512 of the land interest. A seventh column shows a city 514 of the land interest. An eighth column shows a source 516 of the land interest and a ninth column shows a tax or parcel number 518 of the land interest.

It should be appreciated that other embodiments feature GUIs that display other data from the land interest records. Alternate embodiments allow a searcher to select the displayed fields and sort the displayed fields. Other embodiments may not feature a search GUI and may have other calculation, search or comparison engines that query and process returned data.

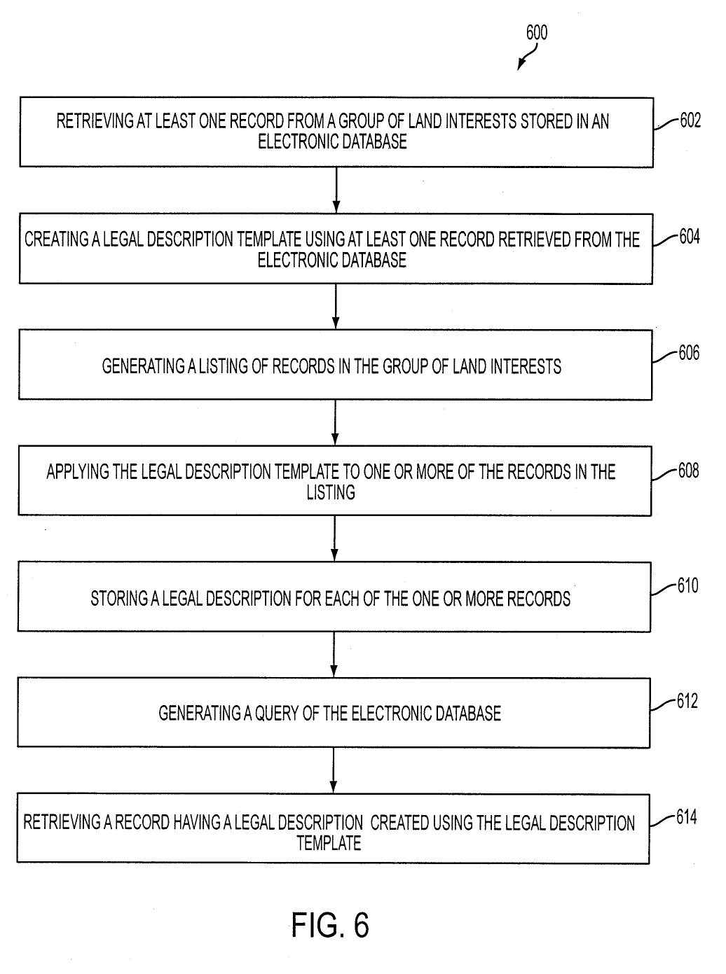

FIG. 6 is a flow diagram of a method 600 to generate a legal description. At least one record from a group of land interests stored in an electronic database is retrieved (block 602). The land interest may be a lot in a tract of land, a condominium unit in a condominium complex or any other land interest that is part of a logical group of land interests.

A legal description template is created using at least one record retrieved from the electronic database (block 604). The legal description of one record may be displayed and edited to create a legal description template that is applicable to many of the records in the group. The TRD 102 may use an intelligent algorithm to determine differences between records in the group and to auto-generate the legal description template.

A listing of records in the group of land interests may then be generated and displayed (block 606). An operator may view the listing to select records to exclude from the application of the legal description template. The TRD 102 may apply an auto application of the legal description template to each of the records in the group.

The legal description template may be applied to one or more records in the listing (block 608). The auto application of the legal description template may auto-generate a legal description for the land interest. The auto-generated legal descriptions may then be checked for accuracy. The legal descriptions may then be stored in the TRD 102 or equivalent (block 610).

A computing device such as a personal computer may query the TRD 102 for information contained in one or more land interest records (block 612). The TRD 102 may retrieve the land interest with a legal description (block 614). The legal description may have been created by the auto-generation process.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. An apparatus for generating a legal description comprising:
a database having one or more groups of land interest records; and
a computing device in communication with the database configured to display a group from the one or more groups of land interest records, display a legal description of at least one land interest record in the group, generate a list of each of the land interest records in the group that do not have a legal description, create a legal description template using the legal description of the at least one land interest record in the group, and apply the legal description template to each of the land interest records in the group that do not have a legal description.

2. The apparatus of claim 1 wherein the one or more groups of land interest records includes a group of lots on a tract of land.

3. The apparatus of claim 1 wherein the one or more groups of land interest records includes a group of condominium units in a condominium building.

4. The apparatus of claim 1 wherein the computing device retrieves the legal description of at least one land interest record in the group from the database.

5. The apparatus of claim 1 further comprising a search engine connected with the database for retrieving the one or more groups of land interest records.

6. The apparatus of claim 5 further comprising a title product generator in communication with the search engine for generating commercial title products associated with the one or more groups of land interest records.

7. A method of generating legal descriptions for land records comprising:
retrieving a group of records of land interests from a database;
creating a legal description template from one of the records in the group of records of land interests having a legal description; and
applying the legal description template to one or more records in the group of records that do not have a legal description.

8. The method of claim 7 further comprising displaying a list of land interest records in the group of records of land interests and selecting one or more land interest records from the list for application of the legal description template.

9. The method of claim 8 wherein application of the legal description template results in a complete legal description being associated with the one or more land interest records.

10. The method of claim 7 wherein the group of records of land interests includes land lot interests.

11. The method of claim 10 wherein the land lot interests include condominium units.

12. The method of claim 10 wherein the land lot interests form at least one complete tract of land.

13. A method of populating a legal description field in a land interest record with a legal description, the method comprising:
retrieving the legal description of a land interest from a record in a database;
creating a template for a group of land records using the legal description; and
applying the template to each record in the group of land records.

14. The method of claim 13 further comprising querying the database and retrieving the record.

15. The method of claim 13 wherein each record in the group of land records does not have a legal description.

16. The method of claim 13 further comprising using the legal description in a title product.

17. The method of claim 13 wherein the template is applied to units in a condominium complex.

18. The method of claim 13 wherein the template is applied to lots in a tract.

19. The method of claim 13 further comprising scanning the group of land records into the database.

20. The method of claim 13 further comprising displaying a list of the group of land records.
